(19) United States
(12) Patent Application Publication
(10) Pub. No.: US 2004/0048149 A1
(43) Pub. Date: Mar. 11, 2004

(54) Battery packaging construction

(76) Inventors: Oliver Gross, Round Rock, TX (US); David Irwin, Larne Co Antrim (GB)

Correspondence Address: Michael D Ross, Valence Technology Inc, 301 Conestoga Way, Henderson, NV, 89015, US

(21) Appl. No.: 10/416,813

(22) PCT Filed: Oct. 30, 2001
(86) PCT No.: PCT/US01/48669

(51) Int. Cl. H01M 2/08

(52) U.S. Cl. 429/127; 429/185; 29/623.2

(57) ABSTRACT

A new battery design is provided. The design is applicable to rectangular prismatic shaped batteries, and improves the reliability through the shaping of the batteries to reduce stresses on the electrochemical cells therein, and the flexible packaging encapsulating the electrochemical cell.

### FIELD OF THE INVENTION

This invention relates to improved battery design in battery packaging construction for improving the reliability of batteries.

### BACKGROUND OF THE INVENTION

Non-aqueous electrochemical cells have become the subject of increasing study and development in recent years, owing to their advantages over conventional electrolyte batteries. Particularly promising are non-aqueous cells comprising a cathode including a metal oxide, chalcogenide, or phosphate active material, for instance a lithium metal oxide, a polymer electrolyte, and an anode including an active material capable of storing or releasing ions during cell operation. The particular advantages of non-aqueous metal oxide electrochemical cells include lower weight than conventional liquid-electrolyte batteries, long service life, relatively high energy densities, and relatively high specific energies.

A typical non-aqueous electrochemical cell, such as a rechargeable lithium ion cell, includes, sequentially, a cathode, a separator, and an anode sandwiched together to form the cell. This cell precursor can be extracted and activated with electrolyte to form a functional cell. More particularly, an electrolyte salt solution is imbibed into a polymeric matrix separator, yielding the “activated” functional cell.

A typical electrochemical battery comprises several such electrochemical cells in which the current from the opposite polarity electrodes of each cell is accumulated by current collectors.

Presently favored electrochemical cell types include the “bi-cell,” characterized by a central electrode (either anodic or cathodic) flanked by two counter-electrodes. Specifically, a conventional bi-cell comprises, in sequence, a first counter-electrode with a current collector, a first separator, a central electrode with a current collector, a second separator, and a second counter electrode having a current collector.

In order to connect an electrochemical cell to an external load, the cell is provided with electrically conductive connectors or tabs associated with the opposite polarity electrodes of the cell. Typically, the current collectors of an electrochemical cell include integral tab portions or separate, primary current collectors associated with the cell current collectors and comprising tab portions for connecting the cell to an external load. Exemplary electrical connectors for an electrochemical cell stack are described in U.S. Pat. No. 5,300,373, assigned to Valence Technology, Inc., which disclosure is incorporated herein by reference in its entirety.

Electrochemical cells, including bi-cells, may be packaged in flexible, bags, pouches, or other containers. According to this type of packaging, the electrochemical cell is essentially sealingly enclosed within the packaging and a portion of the electrical connectors of the cell protrude therefrom to permit electrical contact between the connector and an external load. The packaging forms an essentially sealed enclosure which impedes or prevents infiltration of air and/or moisture into the package. Exemplary layered laminate packaging materials include, but are not limited to, multilayer plastics and barrier materials described in U.S. Pat. Nos. 4,997,732 and 5,445,856, incorporated herein by reference in their entirety. Such materials prevent, or at least inhibit, transport of electricity, oxygen and water therethrough.

The manufacture of batteries, and particularly lithium metal type batteries, seek several goals. Among the goals, the completed battery must be lightweight, compact, and designed to withstand shocks resulting from shipping, storage and use. The packaging materials must be inexpensive and easily fabricated. A common battery shape is the rectangular prismatic shape, i.e. a box shape, where electrochemical cells are of a rectangular prismatic shape, encapsulated in a flexible packaging material, and then encased in a rigid or semi-rigid container having the same shape. The encapsulating flexible packaging material is sealed containing the cell components and an electrolyte solution, and to prevent air, water vapor, and other contaminants from reacting with cell components and the electrolyte solution. The flexible package when sealed has a sealing flange, which is folded along the sides of the cell. The folding of the sealing flange requires a compound fold of the seals at the corners in a formed package to conform with the shape of the rigid container. The sharp corners in the formed package generate stresses on the flexible packaging material and results in material failure. There is a need for improvement in the design for increasing the reliability of the flexible packaging material, and the electrochemical cells contained therein.

### SUMMARY OF THE INVENTION

The present invention provides design improvements resulting in improved reliability and simplification of the manufacturing process. The invention relates to a battery of the type including a cell comprising an electrode, a counter electrode, and a separator disposed between the electrode and counter electrode, the cell having generally planar sides, and edges defined by the intersection of adjacent sides; a flexible package encapsulating the cell including a peripheral sealing flange having a width and sealing the flexible package and folded against the sides of the cell to conform the flange to the cell configuration; and a container for housing the encapsulated cell and having planar sides and intersecting edges that generally conform with the planar sides and the intersecting edges of the encapsulated cell.

According to the invention, a chamfer is provided between adjacent planar sides of the cell to create spaces between the chamfers of the cell and the planar sides and intersecting edges of the container of sufficient size to accommodate folded material of the sealing flange at the corners of the battery. The chamfer provides space sufficient to reduce stresses on the flexible packaging material and on the cell, thereby reducing failure of the package or delamination of the cell.

In one embodiment, the chamfer is an angled cut on the cell. The chamfer cut is typically a straight cut, made at 45 degrees, and at a depth equal to the width of the sealing flange. In an alternative, the chamfer cut is a rounded curve approximating a cylindrical cut.

### BRIEF DESCRIPTION OF THE DRAWINGS

FIG. 1 is a view of a prior art rectangular prismatic cell configuration and sealed flexible packaging with a sealing flange;

FIG. 2 is a top view of the prior art cell of FIG. 1;

FIG. 3 is a view of the prior art rectangular prismatic cell configuration of FIG. 1 with the sealing flanges folded along the sides of the cell;

FIG. 4 is a top view of the prior art cell of FIG. 3;

FIG. 5 is a top view of the prior art cell of FIG. 3 inserted in a container;

FIG. 6 is a top view of a cell with a sealing flange and a chamfer according to the invention;

FIG. 7 is a top view of the cell of FIG. 6 with the sealing flange folded along the sides of the cell;

FIG. 8 is a perspective view of the cell of FIG. 6;

FIG. 9 is a top view of a cell with a chamfer having a rounded cut according to the invention;

FIG. 10 is a top view of a cell with rounded cut approximating a straight bevel cut according to the invention; and

FIG. 11 is a top view of the cell of FIG. 8 inserted in a container.

### DETAILED DESCRIPTION OF THE PREFERRED EMBODIMENTS

The present invention provides a new battery design for batteries having a general structure that consists of planar sides, and edges formed by the intersection of the sides. Batteries of these shapes, generally a rectangular prism, have an external rigid, or semi-rigid, container that conforms to the shape of an electrochemical cell positioned within the container and having corresponding sides and edges. The electrochemical cell comprises one or more individual cells, where an individual cell comprises an electrode, a counter electrode, and a separator disposed therebetween. The electrochemical cell has a length and a width that corresponds to the length and width of the individual cells that make up the electrochemical cell, and a thickness which is the sum of the thicknesses of the individual cells making up the electrochemical cell. An individual cell can also comprise a bi-cell, where a bi-cell comprises a first electrode, a first separator, a central counter electrode, a second separator, and a second electrode. The electrochemical cell is encapsulated in a moisture and air impermeable flexible package before insertion into the rigid container.

The electrochemical cell 10 of the illustrated embodiments comprises a stack of cells of known construction; that is, each cell having arranged in sequence an electrode, a separator element, and a counter electrode. The electrode and counter-electrode of each cell further includes a collector, the electrode collectors for each cell being electrically connected, and the counter-electrodes for each cell being electrically connected. Those of skill in the art will appreciate from this disclosure that the type and number of electrochemical cell(s) contained within the package 18 is not limiting of the present invention, which may readily be adapted to any flexible package battery. It will also be appreciated from the remainder of this disclosure that the electrochemical cell may be of any known type and composition which lends itself to flexible packaging and, as used herein, the term “electrochemical cell” is intended to contemplate all such electrochemical cells, whatever their composition or number.

The flexible package 18 of the illustrated embodiments is of known design and construction, comprising most generally a vapor-impervious, non self-supporting material, for instance a sealed foil pouch. Battery packaging of this type may be plastically formed, or may be pouched. Both formed and pouched structures are generally heat-sealed. According to pouched structures, the at least one electrochemical cell 14 is enclosed between heat-sealed laminated layers which form the pouch. The pouch is sealed around the electrode tabs 16 while permitting the tabs 16 to extend from the pouch so that the battery is connectable to an external load. Battery packaging materials will vary according to manufacturer. However, by way of non-limiting example, in a typical laminate package material, a foil layer is provided centrally in the laminate to render the pouch essentially impermeable to liquid or vapor, and to lend some rigidity to the package. Interiorly of the foil layer is provided an inner strata of material that is non-reactive with the battery electrolyte, for instance a polyamide such as nylon. The inner strata also typically includes a heat-fusible sealing layer, and may further include tie layers (to adhere layers in position), or other layers promoting formation or duration of the laminate material or pouch. On the opposite surface of the foil layer is typically provided an outer laminar strata which serves as a package insulator, provides physical protection for the package, and permits package labeling or marking. While an exemplary flexible package has been described, however, those of skill will appreciate from the remainder of this disclosure that the present invention is well suited to use with any essentially sealable package material.

Electrode tabs 16, current collectors, are also well known. In a battery structure comprising multiple cells, the comparable current collectors/tabs 16 of each cell (anodic or cathodic, respectively) are electrically interconnected. This electrical interconnection may comprise a separate electrical connector, such as a conductive strip of copper wire or sheet, or individual cells may comprise part of a continuous laminate structure folded upon itself such that successive current collecting layers are in electrical contact. The disclosure of U.S. Pat. No. 5,300,373, incorporated herein by reference, teaches one such type of interconnection where a battery comprising a continuous laminate web fan-folded such that opposite polarity electrode segments contact an electrolyte layer on the top and bottom sides of each of the opposite polarity electrode segments. Opposite polarity electrode current collectors are provided. In one arrangement, the cathode current collector is arranged across the cathode layer at each fold thereof in the continuous cathode laminate; and the anode current collector is arranged across individual current collector strips each positioned adjacent an anode segment in the battery structure. Other arrangements are known in the art such as described in the disclosure of International Patent Application WO 97/08769, where a battery comprising multiple individual laminate cells is structured such that the cathode current collector of each cell is in electrical contact, for instance by stacking the individual cells one on top of the other. Each anode includes a separate current collector interconnected by an electrical connector in the form of a strip of conductive material. In one arrangement as described in U.S. Pat. No. 5,300,373, anode current collector means are attached to respective anode current collectors/tabs 16 at predetermined locations; and cathode current collector means are attached to the continuous cathode layer current collector/tab 16 at predetermined locations.

The rigid container is sized to accommodate the electrochemical cell in its flexible package, but is also sized to have a secure fit to prevent the electrochemical cell from moving within the rigid container. This secure fit presents a problem that is known in the battery industry. Specifically, the flexible package when sealed has a seal, called a sealing flange, around the periphery of the electrochemical cell. The flexible package when sealed to enclose the cell creates an encapsulated electrochemical cell. The sealing flange is folded along the sides of the electrochemical cell to fit within the rigid container. A consequence of the folding of the sealing flanges is the requirement to have a three step compound fold at each corner of the electrochemical cell before inserting the encapsulated electrochemical cell into the rigid container. The tight fit creates stresses on the corners of the electrochemical cell and on the flexible package encapsulating the electrochemical cell. The stresses created result in increased failure of the flexible package, and increased delamination of the electrochemical cells.

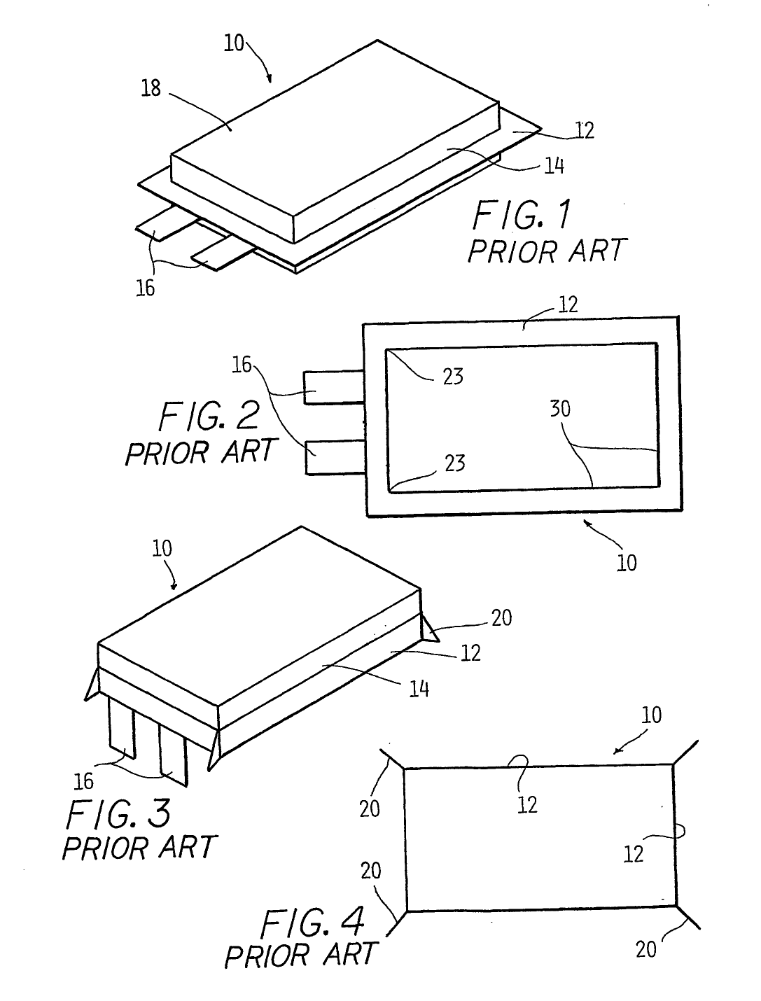

This problem with the prior art configuration is illustrated in FIGS. 1 and 3, where an encapsulated electrochemical cell 10 includes an electrochemical cell 14, electrode tabs 16, an encapsulating flexible package 18 sealed around the electrochemical cell 14, and the seal forming a sealing flange 12. The sealing flange 12 is subsequently folded on four sides, as seen in FIG. 5, to fit the encapsulated cell 10 into a rigid or semi-rigid container 19. The folds form a corner piece 20, which must be subsequently folded against one of the sides of the encapsulated cell 10. This extra material from the folded flange when folded against the cell 10 and inserted into a container creates stress on the flexible package 18 at the corners, and additional stress on the electrochemical cell 14. The stress can result in failure of the package 18 resulting in leakage of electrolyte solution, or deleterious exposure to air or moisture. An additional problem is the possible delamination of the electrochemical cell 14, or a portion of the cell, resulting in regions having lower capacity. The encapsulated cell 10 is seen in FIG. 2 before folding of the sealing flange 12, and is seen in FIG. 4 after folding of the sealing flange 12. To form the corner piece 20 that is seen in FIGS. 3 and 5 wherein the encapsulated cell is seen fitted in the container 19, FIG. 5, with the corner pieces 20 squeezed between the cell 10 and the container 19.

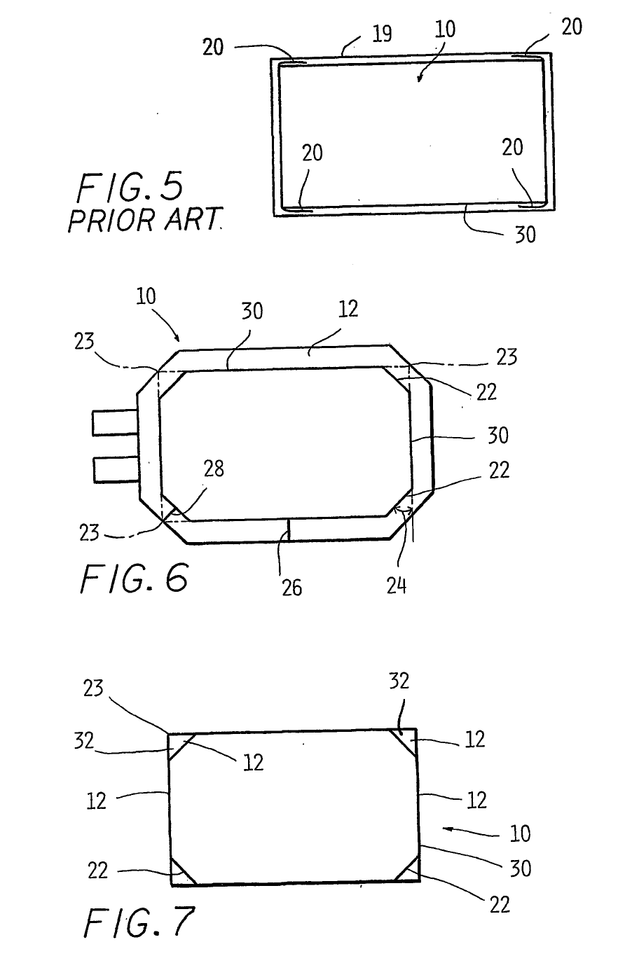

The present invention concerns the unexpected result that by removing small amounts of the electrochemical cells, there was improved reliability and performance of batteries having a rectangular prismatic shape. Specifically, removal of small amounts of material from the electrochemical cells where the compound folds of the flexible package resided resulted in a double benefit, first the reduction in stresses in both the flexible package and the electrochemical cells, and second the elimination of the need for compound folds in the sealing flange at the corners. The removal of sharp corners from the battery's generally rectangular shape creates a shape that allowed for a sealing flange 12 of a shape as seen in FIG. 6 where the sealing flange 12 follows the perimeter of the newly shaped battery.

As seen in FIG. 6, chamfer cuts are performed on each layer, electrode, counter electrode, and separator, before lamination of the electrode, separator, and counter electrode. The sealing flange has a width 26, and the width 26 of the flange is of sufficient size to insure the integrity of the seal, but less than the thickness of the electrochemical cell. Typically, the sealing flange width 26 will be about one half the thickness of the electrochemical cell. Prior to this invention, the cells had a substantially rectangular appearance, as in FIG. 2, and the sides 30 of the cell intersected at corner points 23. The invention provides for the design of cells without material at the corner points 23. The chamfers 22, in FIG. 6, are cut to a depth 28 equal to or greater than the width of the sealing flange 12. The depth 28 of the chamfer 22 is the distance from the chamfer 22 to the corner point 23.

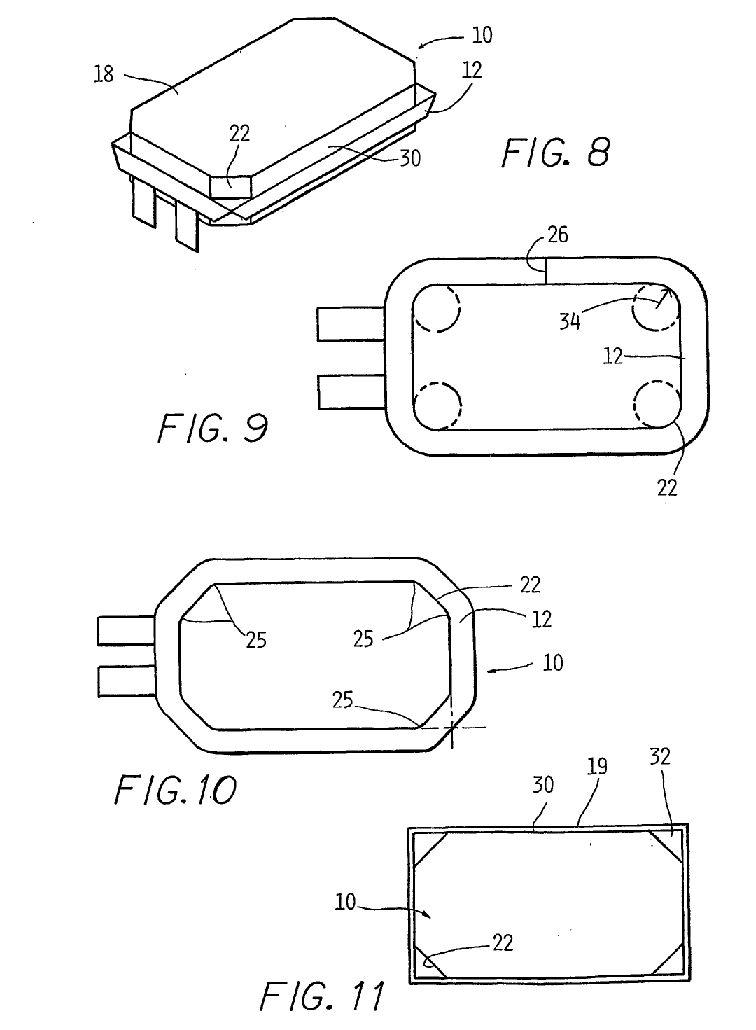

Each chamfer 22 is cut such that an angle 24 is formed between the plane of one side 30 of the electrochemical cell 14 and the chamfer 22. The angle 24 can be between about 20 degrees and about 70 degrees, with a preferred angle of about 45 degrees. When the flange 12 is folded along the sides 30 of the cell 10, as shown in FIG. 7, portions 32 of the flange 12 remain unfolded. These portions 32 do not need to be folded to enable the sealed cell 10 to be inserted into the rigid container 19 as seen in FIG. 11. In addition, the rigid container does not need as precise construction at the corners to accommodate the cell 10. While the depth 28 of the chamfer 22 has a preferred depth equal to the width 26 of the sealing flange, the depth 28 can be increased, and is only limited by the practical aspect of chamfers 22 intersecting when providing too deep a cut. The depth 28 of the chamfer 22 can also be less than the width 26 of the sealing flange 12. In the case of a chamfer 22 having a depth 28 less than the width 26 of the sealing flange 12, the depth must be sufficient to accommodate any excess folded sealing flange 12. A lower limit to the depth 28 of the chamfer 22 is about one half the width of the sealing flange 12. The improved battery design is shown in an isoparametric view in FIG. 8 with the sealing flange 12 folded along the sides 30 of the cell 10. With this improved design, it is apparent there is no excess sealing flange 12 material that requires special folding.

The term chamfer, as used herein, refers to more than just a straight cut, but to any shaping of a battery wherein material has been removed between adjacent sides at a corner of the battery, or wherein the battery has been shaped without the corner material between adjacent sides. Thus, in an alternate embodiment, as shown in FIG. 9, the chamfers 22 are rounded. The chamfers 22 are cut to approximate a cylindrical cut having a radius of curvature 34 of about 2.4 times the width 26 of the sealing flange. Larger cylindrical cuts are possible, and are only limited by the practical aspect of the cylindrical chamfers 22 intersecting when providing too deep a cut. Smaller cylindrical cuts are possible, and the cylindrical cut must be of sufficient depth to accommodate any excess folded sealing flange. A lower limit for a cylindrical cut would be a cut having a radius of curvature 34 of about 0.7 times the width of the sealing flange.

In another alternate embodiment, as shown in FIG. 10, the chamfer 22 approximates a straight cut with rounded ends 25 for convenience or other practical limitations presented by the equipment used in forming the electrochemical cell 14. The invention is intended to include any curve, whether straight, convex, or concave in shape, so long as the depth requirements are met.

A battery with a chamfer is formed by shaping the corners of the electrochemical cell stack, including the separators and electrodes. The fabrication of electrodes and separators is described in U.S. Pat. No. 5,871,865, and is incorporated herein. The corner shaping is performed before lamination of the battery components, or is performed after the assembly of the electrodes and separators into electrochemical cells. The chamfered cells are inserted into flexible packaging, and the flexible packaging is sealed. The sealed flexible package is then inserted into a rigid container.

In summary, the invention provides a new battery design for rectangular prismatic shaped batteries which provides improved reliability by reducing incidence of delamination and reducing incidence of failure of the flexible packaging, and relaxes the tolerances of the rigid container conforming to the shape of the electrochemical cell in the corner regions.

While this invention has been described in terms of certain embodiments, it is not intended to be limited to the above description, but rather only to the extent set forth in the following claims.

What is claimed is:

1. A battery assembly comprising a cell comprising an electrode, a counter electrode, and a separator disposed between the electrode and counter electrode, the cell having generally planar sides, and edges defined by the intersection of adjacent sides; a flexible package encapsulating the cell including a peripheral sealing flange sealing the flexible package and folded against the sides of the cell to conform the flange to the cell configuration; and a container for housing the encapsulated cell and having planar sides and intersecting edges that generally conform with the planar sides and the intersecting edges of the encapsulated cell; characterized in that:
at least one chamfer is provided between adjacent planar sides of the cell to create a space between each chamfer of the cell and the planar sides and intersecting edges of the container of sufficient size to accommodate folded material at the corners of the folded down sealing flange.

2. The battery of claim 1 wherein the chamfer is of sufficient size to provide a sealing flange wherein the intersections of lines drawn along the sides of the cell, where the sealing flange is proximate to the cell, lie outside outer edges of the unfolded sealing flange so that the folds of the sealing flange do not intersect.

3. The battery of claim 1 wherein the chamfer is a cut defined by an angle formed by a plane along a planar side of the cell with a plane formed by the chamfer, the depth of the chamfer is the normal distance from the chamfer to the edge defined by the intersection of the two planar sides cut to form the chamfer, and the angle of the chamfer is an angle from about 20 degrees to about 70 degrees.

4. The battery of claim 3 wherein the sealing flange has a width and the chamfer is at an angle of about 45 degrees, and the depth of the chamfer is greater than the width of the sealing flange.

5. The battery of claim 1 wherein the sealing flange has a width and the chamfer is a rounded cut defined by a cylinder contacting the adjacent planar sides and having a radius of curvature of at least 70% the width of the sealing flange.

6. The battery of claim 5 wherein the chamfer is a rounded cut wherein the radius of curvature is about 240% the width of the sealing flange.

7. The battery of claim 1 wherein the chamfer is a straight cut along a mid portion, with a rounded corner adjacent with each planar side.

8. A battery assembly comprising:
a cell comprising an electrode, a counter electrode, and a separator therebetween;
the cell having a generally rectangular prismatic shape, defined by generally planar sides and edges defined by the intersection of adjacent sides;
a flexible package encapsulating the cell including a peripheral sealing flange sealing the flexible package, said sealing flange having a width and folded against the sides of the cell;
a container for housing the encapsulated cell having planar sides and intersecting edges that conform with the sides and edges of the encapsulated cell; and
at least one chamfer between adjacent sides of the cell to create a space between each chamfer of the cell and the planar sides and intersecting edges of the container, said chamfer having a depth equal to the width of the sealing flange.

9. A battery assembly comprising a cell comprising an electrode, a counter electrode, and a separator disposed between the electrode and counter electrode, the cell having generally planar sides, and edges defined by the intersection of adjacent sides; and a flexible package encapsulating the cell including a peripheral sealing flange sealing the flexible package; characterized in that:
at least one chamfer is provided between adjacent planar sides of the cell, said planar sides lying in intersecting planes.

10. The battery of claim 9 wherein the chamfer is of sufficient size to provide a sealing flange wherein the intersections of lines drawn along the sides of the cell, where the sealing flange is proximate to the cell, lie outside outer edges of the unfolded sealing flange such that the folds of the sealing flange do not intersect.

11. The battery of claim 9 wherein the chamfer is a cut defined by an angle formed by a plane along a planar side of the cell with a plane formed by the chamfer, the depth of the chamfer is the normal distance from the chamfer to the edge defined by the intersection of the two planar sides cut to form the chamfer, and the angle of the chamfer is an angle from about 20 degrees to about 70 degrees.

12. The battery of claim 9 wherein the sealing flange has a width and the chamfer is a rounded cut defined by a cylinder contacting the adjacent planar sides and having a radius of curvature of at least 70% the width of the sealing flange.

13. The battery of claim 9 wherein the chamfer is a straight cut along a mid portion, with a rounded corner adjacent with each planar side.

14. A battery assembly comprising:
a cell comprising an electrode, a counter electrode, and a separator therebetween, the cell having a generally rectangular prismatic shape, defined by generally planar sides and edges defined by the intersection of adjacent sides;
at least one chamfer between adjacent sides of the cell, said adjacent sides lying in intersecting planes; and
a flexible package encapsulating the cell including a peripheral sealing flange sealing the flexible package.

15. A method of forming a battery assembly comprising the steps of:
forming a cell comprising an electrode, a counter electrode, and a separator therebetween, the cell having a generally rectangular prismatic shape, defined by generally planar sides and edges defined by the intersection of adjacent sides;
forming at least one chamfer between adjacent sides of the cell to create a space between each chamfer of the cell and the planar sides and intersecting edges of the container, said chamfer having a depth equal to the width of the sealing flange;
encapsulating the cell in a flexible package including a peripheral sealing flange sealing the flexible package, said sealing flange having a width and folded against the sides of the cell; and
inserting the encapsulated cell into a container having planar sides and intersecting edges that conform with the sides and edges of the encapsulated cell.
